(19) United States
(12) Patent Application Publication
(10) Pub. No.: US 2007/0118517 A1
(43) Pub. Date: May 24, 2007

(54) Information management method using key-coded words

(76) Inventor: Ben Gill-Ho Lee, Fullerton, CA (US)

Correspondence Address: Ben Gill-Ho Lee, 2136 Weatherly Place, Fullerton, CA, 92833, US

(21) Appl. No.: 11/284,591

(22) Filed: Nov. 21, 2005

(51) Int. Cl. G06F 17/30

(52) U.S. Cl. 707/5

(57) ABSTRACT

An information management method relates to make the connection between depositor (22) and searcher (24), using words (31W, 41W) of natural language. The word (31W, 41W) is attached with at least one predefined key-code (31K, 41K) which stands for at least one of the pre-analyzed subject-matters of the item and the associated depositor (22), forming a key-coded word (31, 41). The depositor (22) and the searcher (24) use the same key-codes (31K, 41K) with the words (31W, 41W) so as to attain consensus in communicating with each other, not only for single word query but also for the full text query.

### FIELD OF THE INVENTION

This invention relates to information management to make the connection between depositor who stores information of at least one item thereof into data-storage and searcher who searches the item interesting.

### BACKGROUND AND SUMMARY OF THE INVENTION

It has been taken substantial part of lifetime as a searcher to search for interesting items and depositors. Also, the depositor spends considerable time and money so as to be contacted by the searchers who are interested in the item.

It is relatively common in the computerized searching environment to use words of natural language, for the depositor to use text-words to store information of the associated item, and for the searcher to use keywords to retrieve the depositor of which the text-words are matched with the keywords of the searcher.

The text-word and keyword each are a literal value of which the meaning also implies at least one of subject-matters of the item and the associated depositor, such as item-title, item-function, item-category, item-locality, depositor-title, and others. In the case that the word can explicitly express the particular subject-matter implied with the word, the retrieving process can be much easier, faster, and more precise.

The conventional methods and the related art for the retrieval system are involved to search all the data or outlines of the data stored in the system, and the outlines are in the narrative or preformatted form. In many of those approaches to the data, the system is engaged to extract, convert, index, generate, parse, normalize, or parameterize the data stored in the system. The role of the system is to adapt the term representation rules which are so numerous and various with the symbolic meanings of the terms. Therefore it is difficult to have the consensus for the implied meanings between the text-words and the keywords unless the sophisticated and huge directory lists are provided to assist the searchers, resulting to the unexpected retrievals especially in real time with the full text query.

The prior attempts described in U.S. Pat. No. 6,687,711 issued Feb. 3, 2004 and U.S. Pub. 20050251534 dated Nov. 10, 2005, to Nunez, show methods engaged to parameterize the data value in a file by pairing the data value with the parameter name which is created by the system or by the creator of the system. Nunez's methods have the burden of the data conversion and the data size. Also the parameter names stored in the system are not cleared for the searchers to presume the specific parameter name for the particular keyword.

This invention is drafted by pre-analyzing the subject-matters of the item and the associated depositor, and by predefining a plurality of key-codes of which each stands for at least one of the pre-analyzed subject-matters. The text-word and keyword each are attached with the appropriate key-code to explicitly express the subject-matter implied with the word, so as to attain the consensus between the depositor and the searcher, not only for the single keyword query but also for the full text query.

The object of this invention is to make the retrieved result more precise in the logically and explicitly intended manner.

Another object is to make the data size smaller, to make the data storing process easier to handle, to make the retrieval process faster, and to display the retrieved result in less space on the screen of the monitor.

Another object is to eliminate the directory lists needed to assist the depositor and searcher.

Another object is to provide the guide to the possible text-words and keywords with respect to the pre-analyzed subject-matters, in the same manner with the depositor and searcher each other.

The effect of the above advantages is increased for the depositor and searcher who use the portable computer with small sized monitor such as cellular phone, wireless PDA, and wireless pocket PC.

### BRIEF DESCRIPTION OF THE DRAWINGS

FIG. 1 is a diagram showing an overall exemplary system for this invention.

FIG. 2 is a diagram showing a portion of an optical interface for a depositor with a submit button and a text field showing key-coded text-words therein.

FIG. 2A is a diagram showing the key-coded text-words in FIG. 2 in detail.

FIG. 3 is a diagram showing a portion of an optical interface for a searcher with a search button and a text field showing key-coded keywords therein.

FIG. 4 is a diagram showing the structure for a supplier entity in data-storage.

FIG. 5 is a diagram showing the structure for a receiver entity in data-storage.

FIG. 6 is a diagram showing the structure modified from FIG. 4, which further includes an item entity.

FIG. 7 is a diagram showing the structure modified from FIG. 6, which further includes a coded-texts entity.

### DETAILED DESCRIPTION

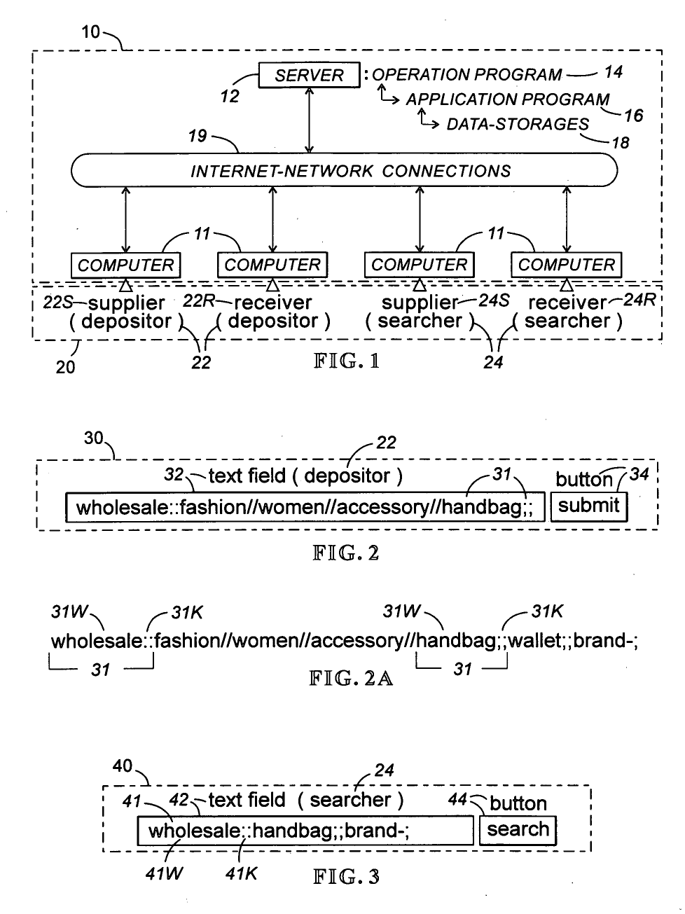

FIG. 1 shows an exemplary embodiment 10 for this invention comprises a plurality of client computers 11, a server 12, and internet-network connections 19 to the client computers and the server. The client computers 11 and the server 12, each has typical components such as processor (e.g. CPU) (not shown), communication devise (e.g. network card, router, modem card) (not shown), operation program (e.g. Windows, Mac, Linux) 14, and memory (e.g. hard disk, CD, tape) (not shown). The client computer 11 further includes input device (e.g. key-board, mouse) (not shown) and output devise (e.g. monitor, printer) (not shown).

The server 12 further includes application-program 16 and data-storage 18. The data-storage 18 (e.g. data file, database file, database file with the nested database files) which contains the data in the various format (e.g. TXT, PDF, MDB, HTML) and in the various structure (e.g. spread-sheet, relational database model, network database model), is saved in the memory of the server 12. The application program 16 has functionalities to manipulate, text-search, and retrieve the data stored in the data-storage 18, using programming-languages (e.g. HTML, ASP, Cold-Fusion, JSP, SQL). The application program 16, also has functionalities to provide optical interfaces 30 in FIG. 2, 40 in FIG. 3 to the client computers 11 so as to listen and respond back to the events (e.g. mouse-click, keyboard-typing) of clients 20. The operation program 14 has functions to communicate with the client computers 11 and the application program 16.

The client 20 is the one who use client computer 11 which is connected to the server 12. The client 20 represents one of an individual, a group of individuals, a team, a company, a corporation, an organization, a web-site published, and other which can be identified as an entity with the unique name thereof.

The Client 20 is also entitled as a depositor 22 or a searcher 24. The depositor 22 is allowed to store the information of at least one item thereof with one or more text-words 31W in FIG. 2A into the data-storage 18. The searcher 24 is the one who requests to search and retrieve the data stored in the data-storage 18, using one or more keywords 41W in FIG. 3.

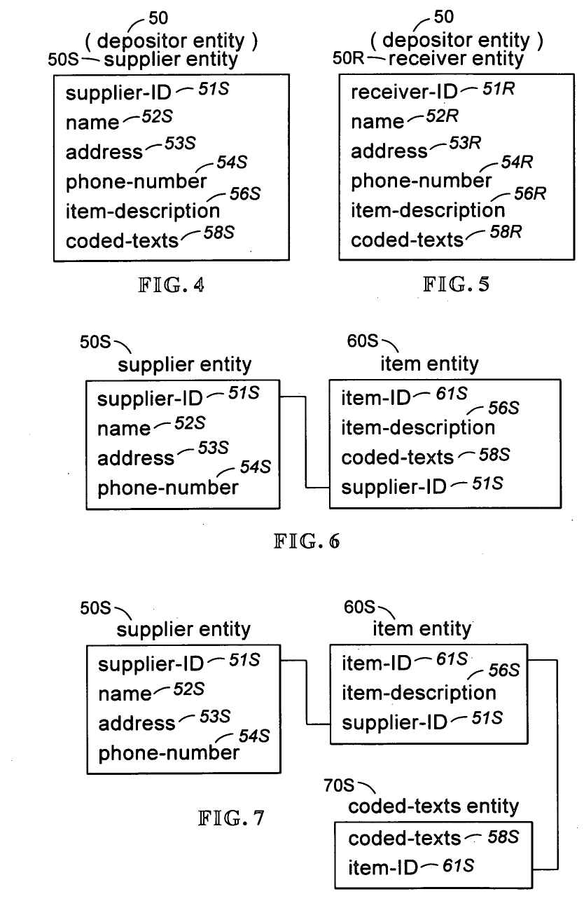

The client 20 is also entitled as a supplier 22S, 24S or a receiver 22R, 24R. The supplier 22S, 24S is the one who has capability to assign, initiate, sell, perform, or otherwise supply at least one item. The receiver 22R, 24R is the one who is willing to be assigned, be initiated, buy, hire, or otherwise receive the item. The supplier 22S who is also the depositor 22, stores the information of the associated item into the data-storage 18 as a supplier entity 50S in FIG. 4, expecting to be searched and get retrieved by the receiver 24R who is also the searcher 24. The receiver 22R who is also the depositor 22, stores the information of the associated item into the data-storage 18 as a receiver entity 50R in FIG. 5, expecting to be searched and get retrieved by the supplier 24S who is also the searcher 24.

FIG. 2 shows a portion of an optical interface 30 which is provided by the server 12 to the depositor 22, showing a text field 32 and a submit button 34. The text field 32 allows the depositor 22 to input the text-words 31W in FIG. 2A. The submit button 34 allows the depositor to mouse-click to send the inputted text-words to the server 12, so that the server can store the text-words into the data-storage 18.

FIG. 3 shows a portion of another optical interface 40 which is provided by the server 12 to the searcher 24, showing a text field 42 and a search button 44. The text field 42 allows the searcher 24 to input the keywords 41W, and the search button 44 allows the searcher to mouse-click to send the inputted keywords to the server 12, so that the server 12 can search the text-words 31W in the data-storage 18, retrieve the items of which the text-words 31W are matched with the keywords 41W, and then return the retrieved result back to the searcher. The retrieved result includes the contact information of the associated depositors 22 so that the searcher 24 can select one or more depositors 22 to contact to.

FIG. 4 and FIG. 5 show the exemplary data structures of the supplier entity 50S and the receiver entity 50R respectively, and both entities 50S, 50R are also entitled as the depositor entity 50. The supplier entity 50S and receiver entity 50R each have the attributes of name 52S, 52R, address 53S, 53R, and phone-number 54S, 54R, which contain the contact information of the supplier 22S and receiver 22R respectively. The supplier entity 50S and receiver entity 50R each also have the attribute of item-description 56S, 56R which contains the detailed data of the associated item with the text-words 31W provided by the supplier 22S and receiver 22R respectively. The supplier entity 50S and the receiver entity 50R each also have the supplier-ID 51S and the receiver-ID 51R respectively, which uniquely identify the supplier 22S and receiver 22R respectively.

Since nowadays the dominant type of database is the relational database model, this embodiment 10 shows a portion of the relational database structure for the illustration purpose, such that the supplier entity 50S and receiver entity 50R each are considered as a record-row of a “suppliers” table and “receivers” table respectively, and each attribute 51S, 52S, 53S, 54S, 56S in FIG. 4, 51R, 52R, 53R, 54R, 56R in FIG. 5 of the entities 50S, 50R is considered as a field-column of the corresponding table.

The item can be classified into one of a plurality of classes, such as material, product, money, business, real estate, work, knowledge, know-how, concept, technique, license, and other of which the items are interrelated with each other. One or more classes can be grouped together, and each group of the classes can be stored in the system memory separately from the other groups. Therefore, as the data volume grow, the data storing process can be easier to manage, and the data searching and retrieving process can be faster.

The text-word 31W in FIG. 2A and keyword 41W in FIG. 4 each, referred as a word 31W, 41W, are a literal value of which the meaning also implies at least one of subject-matters of the item and the associated depositor 22. The subject-matters can be analyzed into item-title, item-function, object of the item-function, item-category, item-locality, depositor-title, depositor-function, object of the depositor-function, object of the item-function, reference, certificate, experience, and other which is considered as the appropriate subject-matter with respect to the specific rules and characteristics commonly recognized by the community related to the item.

The words 31W, 41W can be considered as the tool to communicate with the depositor 22 and the searcher 24 each other. This invention provides the improved communication tool which is implemented with a plurality of predefined key-codes 31K in FIG. 2A, 41K in FIG. 3 of which each stands for at least one of the pre-analyzed subject-matters.

The word 31W, 41W is attached with at least one appropriate key-code 31K, 41K to explicitly express the subject-matter implied with the word, forming a key-coded word 31, 41. The depositor 22 use the text-word 31W attached with the key-code 31K, referred as a key-coded text-word 31 in FIG. 2A. And the searcher 24 use the keyword 41W attached with the key-code 41K, referred as a key-coded keyword 41 in FIG. 3. Since the depositor 22 and the searcher 24 use the same key-codes 31K, 41K, the key-coded text-word 31 and the key-coded keyword 41 can be recognized and utilized by the depositor and the searcher respectively in the same manner with each other so as to attain the consensus in communicating with each other.

Definitions for the specific key-codes 31K, 41K, are listed as following 1 to 10:

1. The text-word 31W and keyword 41W each, which define on at least one of the subject-matters of the depositor-title and depositor-function, are suffixed by a pair of the specific key-code 31K, 41K, for example, a pair of the “colon” key-code such as (::).

2. The text-word 31W and keyword 41W each, which define on the supplement to at least one of the subject-matters of the depositor-title and depositor-function, are suffixed by two specific key-codes 31K, 41K, for example, the “colon” key-code and the “hyphen” key-code such as (:-) or (-:).

3. The text-word 31W and keyword 41W each, which define on at least one of the subject-matters of the reference, certificate, experience, and superiority, which are supplementary to the subject-matters of the depositor-title and depositor-function, are suffixed by two specific key-codes 31K, 41K, for example, the “colon” key-code and the “asterisk” key-code such as (:*) or (*:).

4. The text-word 31W and keyword 41W each, which define on at least one of the subject-matters of the item-title, item-function, object of the depositor-function, and leaf-level of item-category, are suffixed by a pair of the specific key-code 31K, 41K, for example, a pair of the “semicolon” key-code such as (;;).

5. The text-word 31W and keyword 41W each, which define on the supplement to at least one of the subject-matters of the item-title, item-function, object of the depositor-function, and leaf-level of item-category, are suffixed by two specific key-codes 31K, 41K, for example, the “semicolon” key-code and the “hyphen” key-code such as (;-) or (-;).

6. The text-word 31W and keyword 41W each, which define on at least one of the subject-matters of the reference, certificate, experience, and superiority, which are supplementary to the subject-matters of the item-title, item-function, object of the depositor-function, and leaf-level of item-category, are suffixed by two specific key-codes 31K, 41K, for example, the “semicolon” key-code and the “asterisk” key-code such as (;*) or (*;).

7. The text-word 31W and keyword 41W each, which define on the subject-matter of the object of the item-function, are suffixed by a pair of the specific key-code 31K, 41K, for example, a pair of the “comma” key-code such as (,,).

8. The text-word 31W and keyword 41W each, which define on the supplement to the subject-matter of the object of the item-function, are suffixed by two specific key-codes 31K, 41K, for example, the “comma” key-code and the “hyphen” key-code such as (,-) or (-,).

9. The text-word 31W and keyword 41W each, which define on the subject-matter of the item-locality to express the geographic area to which the item and the associated depositor can support, are suffixed by a pair of the specific key-code 31K, 41K, for example, a pair of the “backward slash” key-code such as (\).

10. The text-word 31W and keyword 41W each, which define on the subject-matter of the super-level of item-category which is other than the leaf-level of item-category, are suffixed by a pair of the specific key-code 31K, 41K, for example, a pair of the “forward slash” key-code such as (//).

The above definitions 1 to 10 for the key-codes 31K, 41K, are provisional to illustrate this invention. And also any other key-codes can be assigned for the other specific subject-matters of the item, for example, a pair of the “dollar sign” key-code such as ($$) for the item-price, a pair of the “pound sign” key-code such as (##) for the item-size, and a pair of the “circumflex” key-code such as (ˆˆ) for the item-date.

Cases of the actual use of the key-coded text-words 31 and key-coded keywords 41 are listed as following A to D:

A. In the case that a handbag wholesaler wants to be contacted by the potential handbag retailers, the wholesaler is the supplier 22S and also the depositor 22, the retailers are the receivers 24R and also the searchers 24, and the handbag is the item.

More specifically as shown in FIG. 2, FIG. 2A and FIG. 3, the word 31W, 41W, “wholesale” which defines on the depositor-function, is suffixed by a pair of the “colon” key-code 31K, 41K such as (::), as illustrated in the above definition 1. The words 31W, 41W, “handbag” and “wallet” each, which define on the item-title, leaf-level of item-category, and object of the depositor-function, are suffixed by a pair of the “semicolon” key-code 31K, 41K such as (;;), as illustrated in the above definition 4. The words 31W, 41W, “fashion”, “women”, and “accessory” each, which define on the super-level of the item-category, are suffixed by a pair of the “forward slash” key-code 31K, 41K such as (II), as illustrated in the above definition 10. The word 31W, 41W, “brand” which defines on the supplement to the item, is suffixed by the “hyphen” key-code 31K, 41K and the “semicolon” key-code such as (;-) or (-;), as illustrated in the above instruction 5.

FIG. 2A shows an example of the actual use of the key-coded text-words 31 inputted into the text field 32 by the depositor 22 in the above case A, as following;

“wholesale::fashion//accessory//women//handbag;;wallet;;brand-;”.

FIG. 3 shows an example of the actual use of the key-coded keywords 41 inputted into the text field 42 by the searcher 24 in the above case A, is as following;

“wholesale::handbag;;brand-;”.

B. In the case that a bank, which has the specific loan programs, wants to be contacted by the potential borrowers, the bank is the supplier 22S and also the depositor 22, the borrowers are the receivers 24R and also the searchers 24, and the money with the specific loan program is the item.

An example of the actual use of the key-coded text-words 31 and key-coded keywords 41 in the above case B, is as following;

“direct-:lender::quick-;low-;fixed-;home-;equity-;loan;;”.

C. In the case that a roofing company wants to be contacted by the potential customers, the company is the supplier 22S and also the depositor 22, the customers are the receivers 24R and also the searchers 24, and the roofing work is the item.

An example of the actual use of the key-coded text-words 31 and key-coded keywords 41 in the above case C, is as following;

“licensed*:roofer::Houston\\roofing;;repair;;fix;;install;;leak-,old-,roof,,”.

D. In the case that a hirer, which has a job opened for the specific work, wants to be contacted by the potential workers, the hirer is the receiver 22R and also the depositor 22, the workers are the suppliers 24S and also the searchers 24, and the job for the specific work is the item.

An example of the actual use of the key-coded text-words 31 and key-coded keywords 41 in the above case D, is as following;

“employer::3-yrs*;asp-;oracle-;programer;;administrate;;website,,”.

As illustrated in the above definitions 1 to 10 and cases A to D, an advantage of this invention is that the order of the key-coded words 31, 41 is insensitive in understanding the context of the key-coded words, since the key-codes 31K, 41K of the key-coded words are self explanatory of the relationship with the other key-coded words.

Another advantage is that the space delimiter is not required to delimit the key-coded words 31. 41 each other, since each key-coded word 31, 41 is ended by the suffixed key-code 31K, 41K which can function to delimit the following key-coded word.

Another advantage is that the key-codes 31K, 41K can be utilized as the guide to the possible text-words 31W and keywords 41W with respect to the pre-analyzed subject-matters, in the same manner with the depositors 22 and searchers 24 each other.

Another advantage is that the directory lists, such as the lists of item-title, depositor-title, hierarchical category, and geographic area, which may be needed to assist the depositors 22 and searchers 24, can be eliminated, since the key-coded words 31, 41 are self explanatory of the subject-matters of those lists.

Another advantage is that the data with the key-coded words 31 are relatively small in size, so that the data storing process can be easier to manage, the data retrieving process can be faster, and the retrieved result can be displayed in less space on the screen of the monitor.

Another advantage is that the retrieved result can be more precise in the logically and explicitly intended manner, since the depositors 22 and searchers 24 use the same key-codes 31K, 41K to attain consensus with each other. This effect is increased when the searcher 24 uses two or more key-coded keywords 41 to set the condition for the retrieval, so called “full text query”.

The effect of the above advantages is increased for the depositor 22 and searcher 24 who use the portable computer with small sized monitor, such as the cellular phone, wireless PDA, and wireless pocket PC.

As shown in FIG. 4 and FIG. 5, the supplier entity 50S and receiver entity 50R each also have a coded-texts attribute 58S in FIG. 4, 58R in FIG. 5 which contains one or more key-coded text-words 31 in FIG. 2A which are abstracted in the relatively small data size with sole purpose to be searched and get retrieved. Therefore the retrieving process can be faster, and the retrieval result can be more precise in the explicitly intended manner.

FIG. 6 shows the database structure modified from FIG. 4, which further includes an item entity 60S for the item which is not interrelated with other items. The attributes of the item-description 56S in FIG. 4 and the coded-texts 58S in FIG. 4 are relocated to the associated item entity 60S. The item entity 60S also has an item-ID 61S which uniquely identifies the particular item and a supplier-ID 51S which is utilized to cross-reference to the same supplier-ID 51S in the associated supplier entity 50S. Therefore, when the supplier entity 50S has two or more items which are not interrelated each other, the information of each item can be stored as the item entity 60S separately from other item entities.

FIG. 7 shows the database structure modified from FIG. 6, which further includes a coded-texts entity 70S. The coded-texts attribute 58S in FIG. 6 is relocated to the coded-texts entity 70S. The coded-texts entity 70S also has a item-ID 61S which is utilized to cross-reference to the same item-ID 61S in the associated item entity 60S. Since the coded-texts attribute 58S in the coded-texts entity 70S is isolated from other entities 50S, 60S, the retrieving process can be faster, and the storing process can be easier to manage.

The data-storage 18 of this embodiment 10 is considered as the container for the data in one or more forms of electronic text string, text file, spread-sheet file, database file, image file, movie file, web-site file, and other which contains one or more text-words 31W in FIG. 2 searchable via the electronic text-search. However, the data-storage 18 can be in one or more forms of physical document, logo, sign, advertising material, and other which has one or more of text-words 31W, and the searcher 24 can search the data-storage via the searchers physical eyes and cognition which can be used to search the physical text-words and to retrieve the depositor 22 interesting.

Since nowadays the internet is widely popularized, this embodiment 10 shows an example of the internet system. However the server 12 which is not connected to the internet can perform the same management of this invention, using the direct connections with the clients 20, such as telephone, fax, mail, and e-mail. Another deviation of this embodiment 10 is the server 12 which stores the data of only one particular depositor 22 who has the full control of the server. Another deviation of this embodiment 10 is the system including a searcher 24 who has the full functionalities as the server 12 to receive the retrieval request from the other searchers and to search the other servers to collect data as needed, so called “search service” and “search engine”.

In compliance with the statute, this invention has been described in language more or less specific as to structural and methodical features. It is to be understood, however, that the invention is not limited to the specific features shown and described, since the means herein disclosed comprise preferred forms of putting the invention into effect. The invention is, therefore, claimed in any of its forms or modifications within the proper scope of the appended claims appropriately interpreted in accordance with the doctrine of equivalents.

What is claimed is:

1. A resources information management method, comprising the steps of:
storing resources information of at least one item of at least one depositor into data-storage means;
said depositor representing one of an individual, a group of individuals, organization, a web-site published and other that is able to be entitled as a depositor-entity with the specific identification thereof;
said depositor stored information as said depositor-entity in said data-storage means;
said depositor-entity containing one or more text-words that define said item associated with said depositor;
said text-words searched by at least one searcher; and
searching and retrieving said depositor-entity of said item;
retrieval means including one or more keywords that are prepared by said searcher to define said item that interests said searcher;
said text-word and keyword including the word that defines at least one of a plurality of subject-matters of said associated item;
said subject-matters including item-function, item-object of item-function, item-category, super-category of item-category, item-locality, item-price, item-title, depositor-title, item-reference, item-certificate, item-experience, item-advantage, and other that is considered as appropriate subject-matter with respect to the specific rules and characteristics commonly recognized by the community related to said item;
said text-word and keyword defining at least one of said subject-matters of said item, attached with at least one specific key-code that stands for said associated subject-matter, and forming a key-coded text-word and key-coded keyword respectively;
said retrieval means searching the words in said data-storage means;
said retrieval means retrieving said depositor-entity that contains at least one Key-coded text-word matched with one of said key-coded keywords.

2. The method of claim 1, wherein one or more said text-words and keywords, that are supplemental to another text-word and keyword respectively, are grouped together and placed to the beginning side of said associated text-word and keyword respectively, and each is suffixed by at least one specific key-code.

3. The method of claim 2, wherein one or more said supplemental text-words and keywords, that define at least one of said item-reference, item-certificate, and item-experience, each is suffixed by at least one other specific key-code.

4. The method of claim 2, wherein one or more said supplemental text-words and keywords, that define said item-advantage, each is suffixed by at least one other specific key-code.

5. The method of claim 1, wherein two or more said text-words and keywords, that together define one of said subject-matters of said item, are jointed each other by at least one specific key-code.

6. The method of claim 1, wherein one or more said text-words and keywords, that define said item-category and said supper-category of item-category, are grouped together, and each is suffixed by at least one specific key-code.

7. The method of claim 1, wherein one or more said text-words and keywords, that define said item-locality, are grouped together in geographic division sequence with each other, and each is suffixed by at least one specific key-code.

8. The method of claim 7, wherein at least one said text-word and keyword, that defines leaf-level of said item-locality, is suffixed by at least one other specific key-code.

9. The method of claim 1, wherein one or more said text-words and keywords, that define said item-title, each is suffixed by at least one specific key-code.

10. The method of claim 1, wherein one or more said text-words and keywords, that define said depositor-title, each is suffixed by at least one specific key-code.

11. The method of claim 1, wherein one or more said text-words and keywords, that define said item-function, each is suffixed by at least one specific key-code.

12. The method of claim 11, wherein one or more said text-words and keywords, that define said item-object of item-function, each is suffixed by at least one other specific key-code.

13. The method of claim 1, wherein said data-storage means include one or more of physical documents, logos, signs, advertising materials, and others that have one or more physical text-words, and said retrieval means include searching via the physical eyes and cognition of said searcher.

14. The method of claim 1, wherein said data-storage means include one or more of electronic text strings, text files, spread-sheet files, database files, image files, movie files, web-site files, and others that contain one or more text-words, and said retrieval means include searching via the electronic text-search.

15. The method of claim 1, wherein said item is classified into one of a plurality of classes of said items,
said classes include material, product, money, business, real estate, work, knowledge, technique, know-how, concept, license, depositor itself, and other of that item can be assigned, be initiated, be sold, be performed or otherwise be supplied by the one who has possession or control of said item,
one or more classes of said items are grouped together with said associated depositor-entities,
each group of said classes is stored as a classes-entity in said data-storage means separately from other groups of said classes.

16. The method of claim 1, wherein said depositor is also entitled as one of a supplier and a receiver,
said searcher is also entitled as one of a supplier and a receiver,
said supplier has capability to assign, initiate, sell, perform, or otherwise supply said item to said receivers,
said receiver is willing to be assigned, be initiated, buy, hire, or otherwise receive said item from said associated supplier,
said depositor-entity in said data-storage means is also entitled as one of a supplier-entity and a receiver-entity for said supplier and said receiver respectively.

17. The method of claim 1, wherein said depositor-entity has a depositor-ID that uniquely identifies said associated depositor-entity, a contact-attribute that contains the contact information of said associated depositor, and an item-description that contains the information of said associated item in detail,
said depositor-entity also has a text-words-attribute that contains one or more text-words that are provided by said depositor separately from said item-description with the sole purpose to be searched and retrieved via said retrieval means.

18. The method of claim 17, further including an item-entity for said item that is not inter-related with other items,
said item-description and said text-words-attribute are allocated to said item-entity,
said item-entity also has an item-ID that uniquely identifies said item,
said item-entity also has said depositor-ID that cross-references to said depositor-ID in said associated depositor-entity.

19. The method of claim 18, further including a text-words-entity for each text-words-attribute that is allocated to said text-words-entity,
said text-words-entity also has said item-ID that cross-references to said item-ID in said associated item-entity.
